(19) United States
(12) Patent Application Publication
(10) Pub. No.: US 2019/0044162 A1
(43) Pub. Date: Feb. 7, 2019

(54) POWER GENERATION CELL

(71) Applicant: HONDA MOTOR CO., LTD., Tokyo (JP)

(72) Inventors: Yu Tomana, Wako-shi (JP); Kentaro Ishida, Wako-shi (JP)

(21) Appl. No.: 16/047,024

(22) Filed: Jul. 27, 2018

(30) Foreign Application Priority Data
Aug. 4, 2017 (JP) 2017-151368

(51) Int. Cl. H01M 8/0276; H01M 8/1004; H01M 8/0258; H01M 8/0206

(52) U.S. Cl. CPC H01M 8/0276; H01M 8/0206; H01M 8/0258; H01M 8/1004

(57) ABSTRACT

A first metal separator of a power generation cell includes bosses formed between an oxygen-containing gas flow field and a passage bead. A second metal separator includes bosses formed between a fuel gas flow field and a passage bead. A resin film is held and sandwiched between the passage bead of the first metal separator and the passage bead of the second metal separator. The protruding height of the bosses is lower than the protruding height of the passage bead.

### CROSS-REFERENCE TO RELATED APPLICATION

This application is based upon and claims the benefit of priority from Japanese Patent Application No. 2017-151368 filed on Aug. 4, 2017, the contents of which are incorporated herein by reference.

### BACKGROUND OF THE INVENTION

### Field of the Invention

The present invention relates to a power generation cell including a bead seal and a metal separator having bosses.

### Description of the Related Art

In general, a solid polymer electrolyte fuel cell employs a solid polymer electrolyte membrane. The solid polymer electrolyte membrane is a polymer ion exchange membrane. The fuel cell includes a membrane electrode assembly (MEA). The membrane electrode assembly is formed by providing an anode on one surface of the solid polymer electrolyte membrane, and providing a cathode on the other surface of the solid polymer electrolyte membrane. The membrane electrode assembly is sandwiched between separators (bipolar plates) to thereby form a power generation cell (unit cell). In use, a predetermined number of power generation cells are stacked together to thereby form an in-vehicle fuel cell stack, for example.

In the power generation cell, a fuel gas flow field is formed between the MEA and one of the separators, as one of reactant gas flow fields, and an oxygen-containing gas flow field is formed between the MEA and the other one of the separators, as the other one of the reactant gas flow fields. Further, a plurality of reactant gas passages extend through the power generation cell in the stacking direction.

In the power generation cell, a seal member is provided for preventing leakage of reactant gases such as an oxygen-containing gas and a fuel gas, and a coolant. In the power generation cell, as the separators, metal separators may be used. For example, according to the disclosure in the specification of U.S. Pat. No. 6,605,380, in order to reduce the production cost, a bead seal in the form of a ridge is formed as a sealing portion on a metal separator by press forming. Further, in order to allow a reactant gas to flow from a reactant gas passage to a reactant gas flow field (power generation area) with good balance, bosses may be provided between the reactant gas passage and the reactant gas flow field.

### SUMMARY OF THE INVENTION

The present invention has been made in relation to the above conventional technique, and an object of the present invention is to provide a power generation cell in which it is possible to achieve a desired sealing performance by a bead seal formed on a metal separator, and suppress increase in a tightening load applied to a fuel cell stack.

In order to achieve the above object, according to the present invention, a power generation cell includes a resin film equipped membrane electrode assembly (resin film equipped MEA) including a membrane electrode assembly and a resin film provided on an outer periphery of the membrane electrode assembly, and metal separators provided respectively on both sides of the resin film equipped MEA. The power generation cell is formed by stacking the resin film equipped MEA and the metal separators together. Each of the metal separators includes a reactant gas flow field configured to allow a reactant gas to flow along an electrode surface of the membrane electrode assembly, a reactant gas passage connected to the reactant gas flow field and penetrating through the metal separator in a separator thickness direction, a passage bead for sealing, formed around the reactant gas passage and protruding in the separator thickness direction, and bosses configured to distribute flow of a reactant gas. The bosses are provided between the reactant gas flow field and the passage bead, and protrude in the separator thickness direction. The resin film is held and sandwiched between the passage beads of a pair of the metal separators, and the protruding height of the bosses is lower than the protruding height of the passage bead.

Preferably, the metal separator includes an inlet buffer including the bosses provided at an inlet side of the reactant gas flow field, and an outlet buffer including the bosses provided at an outlet side of the reactant gas flow field, and preferably, the protruding height of the bosses of the inlet buffer is lower than the protruding height of the passage bead formed around the reactant gas passage for supplying the reactant gas to the reactant gas flow field, and the protruding height of the bosses of the outlet buffer is lower than the protruding height of the passage bead formed around the reactant gas passage for receiving the reactant gas from the reactant gas flow field.

Preferably, the protruding height of all of the bosses is lower than the protruding height of the passage bead.

Preferably, among the pair of the metal separators, one of the metal separators includes an oxygen-containing gas flow field as one of the reactant gas flow fields, an oxygen-containing gas passage as one of the reactant gas passages, one of the passage beads that is formed around the oxygen-containing gas passage, and one group of the bosses provided between the one of the passage beads and the oxygen-containing gas flow field, and the other one of the metal separators includes a fuel gas flow field as the other one of the reactant gas flow fields, a fuel gas passage as the other one of the reactant gas passages, the other one of the passage beads that is formed around the fuel gas passage, and another group of the bosses provided between the other one of the passage beads and the fuel gas flow field, and preferably, the protruding height of the bosses in the one group is lower than the protruding height of the one of the passage beads, and the protruding height of the bosses in the other group is lower than the protruding height of the other one of the passage beads.

Preferably, top portions of the bosses directly face the resin film.

Preferably, the metal separator includes a bead seal formed around the reactant gas flow field and protruding in the separator thickness direction, and the protruding height of the bead seal is the same as the protruding height of the passage bead.

Preferably, each of the bosses has a circular shape or an oval shape in a plan view.

In the power generation cell of the present invention, it becomes possible to easily achieve a desired sealing performance by the bead seal formed on the metal separator, and suppress increase in the tightening load applied to the fuel cell stack.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing a power generation cell according to an embodiment of the present invention;

FIG. 2 is a front view showing a first metal separator;

FIG. 3 is a cross sectional view of the power generation cell taken along a line III-III shown in FIG. 1;

FIG. 4 is a front view showing a second metal separator; and

FIG. 5 is a cross sectional view of the power generation cell taken along a line V-V shown in FIG. 1.

### DESCRIPTION OF THE PREFERRED EMBODIMENTS

Hereinafter, a preferred embodiment of a power generation cell according to the present invention will be described with reference to the accompanying drawings.

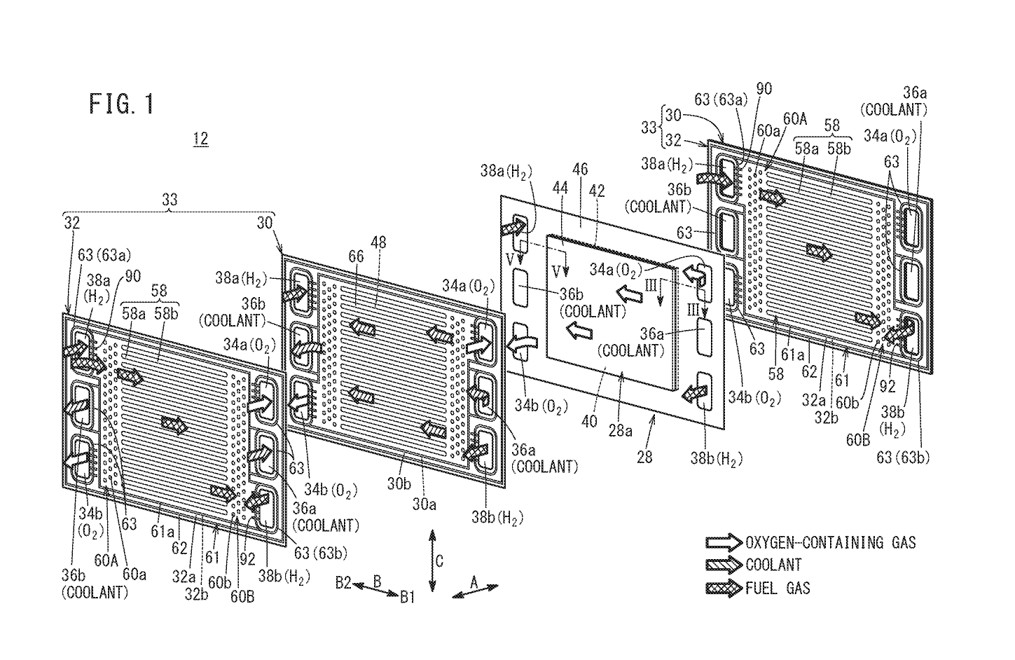

A power generation cell 12, which is a unit cell, shown in FIG. 1 includes a resin film equipped membrane electrode assembly (resin film equipped MEA) 28, a first metal separator 30 provided on one surface of the resin film equipped MEA 28, and a second metal separator 32 provided on the other surface of the resin film equipped MEA 28. For example, a plurality of the power generation cells 12 are stacked in a horizontal direction indicated by an arrow A or in a direction of gravity indicated by an arrow C, and a tightening load (compression load) in the stacking direction is applied to the power generation cells 12, thereby forming a fuel cell stack. For example, the fuel cell stack is mounted as an in-vehicle fuel cell stack in a fuel cell vehicle such as a fuel cell electric automobile (not shown).

Each of the first metal separator 30 and the second metal separator 32 is formed by press-forming a metal thin plate so as to have a corrugated shape in cross section. For example, the metal plate is a steel plate, a stainless steel plate, an aluminum plate, a plated steel plate, or a metal plate having an anti-corrosive surface by surface treatment. In a state where the first metal separator 30 of one of the adjacent power generation cells 12 and the second metal separator 32 of the other one of the adjacent power generation cells 12 face each other, the outer edges of the first metal separator 30 and the second metal separator 32 are joined together by welding, brazing, crimping, etc., to thereby form a joint separator 33.

At one end of the power generation cell 12 in a horizontal direction that is the longitudinal direction, (i.e., an end in a direction indicated by an arrow B1), an oxygen-containing gas supply passage 34a, a coolant supply passage 36a, and a fuel gas discharge passage 38b are provided. The oxygen-containing gas supply passage 34a, the coolant supply passage 36a, and the fuel gas discharge passage 38b extend through the power generation cell 12 in the stacking direction (indicated by the arrow A). The oxygen-containing gas supply passage 34a, the coolant supply passage 36a, and the fuel gas discharge passage 38b are arranged in the vertical direction (indicated by an arrow C). An oxygen-containing gas is supplied through the oxygen-containing gas supply passage 34a. A coolant such as water is supplied through the coolant supply passage 36a. A fuel gas such as a hydrogen-containing gas is discharged through the fuel gas discharge passage 38b.

At the other end of the power generation cell 12 in the horizontal direction that is the longitudinal direction (i.e., an end in a direction indicated by an arrow B2), a fuel gas supply passage 38a, a coolant discharge passage 36b, and an oxygen-containing gas discharge passage 34b are provided. The fuel gas supply passage 38a, the coolant discharge passage 36b, and the oxygen-containing gas discharge passage 34b extend through the power generation cell 12 in the stacking direction. The fuel gas supply passage 38a, the coolant discharge passage 36b, and the oxygen-containing gas discharge passage 34b are arranged in the vertical direction. The fuel gas is supplied through the fuel gas supply passage 38a. The coolant is discharged through the coolant discharge passage 36b. The oxygen-containing gas is discharged through the oxygen-containing gas discharge passage 34b. The layout of the oxygen-containing gas supply passage 34a, the oxygen-containing gas discharge passage 34b, the fuel gas supply passage 38a, and the fuel gas discharge passage 38b are not limited to the embodiment of the present invention, and should be determined according to a required specification.

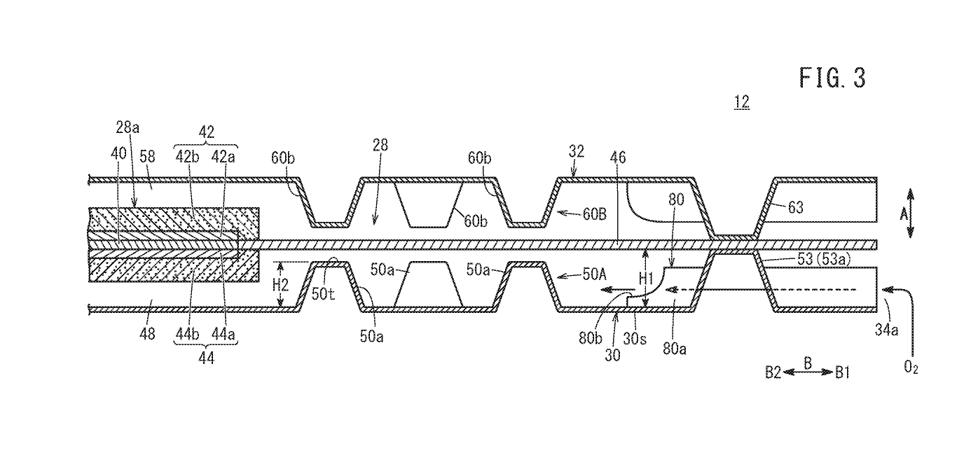

As shown in FIGS. 1 and 3, the resin film equipped MEA 28 includes a membrane electrode assembly 28a, and a frame shaped resin film 46 provided on the outer peripheral portion of the membrane electrode assembly 28a. The membrane electrode assembly 28a includes an electrolyte membrane 40, and an anode 42 and a cathode 44 sandwiching the electrolyte membrane 40.

For example, the electrolyte membrane 40 includes a solid polymer electrolyte membrane (cation ion exchange membrane). For example, the solid polymer electrolyte membrane is a thin membrane of perfluorosulfonic acid containing water. The electrolyte membrane 40 is sandwiched between the anode 42 and the cathode 44. A fluorine based electrolyte may be used as the electrolyte membrane 40. Alternatively, an HC (hydrocarbon) based electrolyte may be used as the electrolyte membrane 40.

As shown in FIG. 3, the cathode 44 includes a first electrode catalyst layer 44a joined to one surface of the electrolyte membrane 40, and a first gas diffusion layer 44b stacked on the first electrode catalyst layer 44a. The anode 42 includes a second electrode catalyst layer 42a joined to the other surface of the electrolyte membrane 40 and a second gas diffusion layer 42b stacked on the second electrode catalyst layer 42a.

The inner end surface of the resin film 46 is positioned close to, and overlapped with or in contact with (in abutment against) the outer end surface of the electrolyte membrane 40. As shown in FIG. 1, at an end of the resin film 46 in the direction indicated by the arrow B1, the oxygen-containing gas supply passage 34a, the coolant supply passage 36a, and the fuel gas discharge passage 38b are provided. At another end of the resin film 46 in the direction indicated by the arrow B2, the fuel gas supply passage 38a, the coolant discharge passage 36b, and the oxygen-containing gas discharge passage 34b are provided.

For example, the resin film 46 is made of PPS (Poly Phenylene Sulfide), PPA (polyphthalamide), PEN (polyethylene naphtalate), PES (polyethersulfone), LCP (liquid crystal polymer), PVDF (polyvinylidene fluoride), a silicone resin, a fluoro resin, m-PPE (modified Poly Phenylene Ether), PET (polyethylene terephthalate), PBT (polybutylene terephthalate), or modified polyolefin.

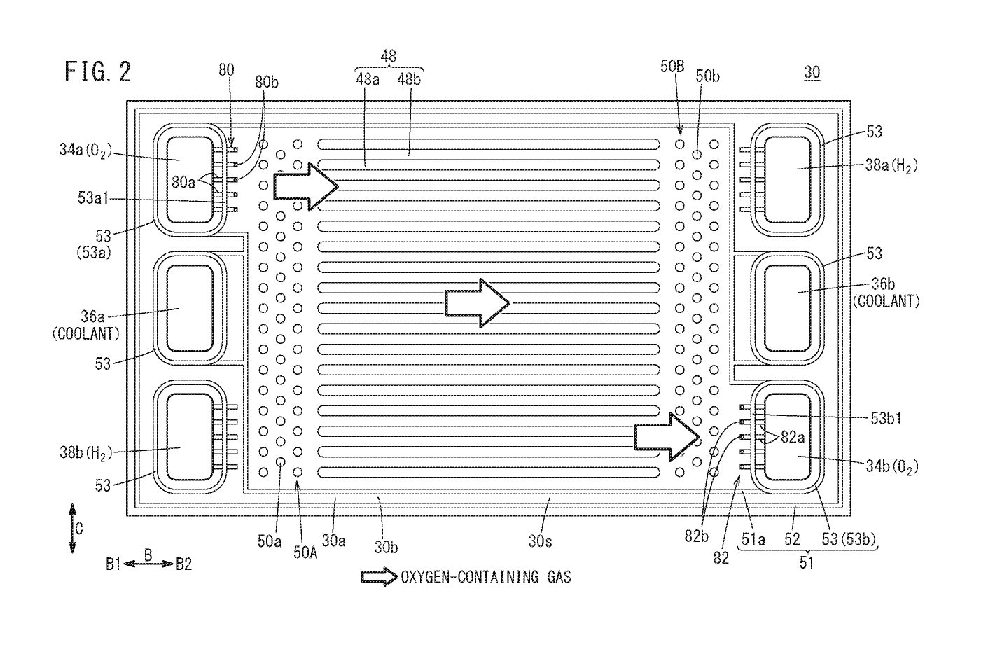

As shown in FIG. 2, an oxygen-containing gas flow field 48 is provided on a surface 30a of the first metal separator 30 facing the resin film equipped MEA 28 (hereinafter referred to as the “surface 30a”). For example, the oxygen-containing gas flow field 48 extends in the direction indicated by the arrow B. The oxygen-containing gas flow field 48 is connected to (in fluid communication with) the oxygen-containing gas supply passage 34a and the oxygen-containing gas discharge passage 34b. The oxygen-containing gas flow field 48 includes straight flow grooves 48b between a plurality of ridges 48a extending in the direction indicated by the arrow B. Instead of the plurality of straight flow grooves 48b, a plurality of wavy flow grooves may be provided.

An inlet buffer 50A including a plurality of bosses 50a is provided on a surface 30a of the first metal separator 30, between the oxygen-containing gas supply passage 34a and the oxygen-containing gas flow field 48. Further, an outlet buffer 50B including a plurality of bosses 50b is provided on the surface 30a of the first metal separator 30, between the oxygen-containing gas discharge passage 34b and the oxygen-containing gas flow field 48. The bosses 50a, 50b have a circular shape in a plan view (view in the stacking direction). The bosses 50a, 50b may have an oval shape or a linear shape in a plan view (view in the stacking direction).

A first seal line 51 is formed on the surface 30a of the first metal separator 30 by press forming. The first seal line 51 protrudes toward the resin film equipped MEA 28 (FIG. 1). Resin material may be fixed to protruding front surfaces of the first seal line 51 by printing, coating, etc. For example, polyester fiber is used as the resin material. The resin material may be provided on the resin film 46.

The first seal line 51 includes a bead seal 51a (hereinafter referred to as the “inner bead 51a”) provided around the oxygen-containing gas flow field 48, the inlet buffer 50A and the outlet buffer 50B, a bead seal 52 (hereinafter referred to as the “outer bead 52”) provided outside the inner bead 51a along the outer periphery of the first metal separator 30, and a plurality of bead seals 53 (hereinafter referred to as the “passage beads 53”) provided respectively around the plurality of fluid passages (oxygen-containing gas supply passage 34a, etc.). The outer bead 52 protrudes from the surface 30a of the first metal separator 30 toward the resin film equipped MEA 28, and circumferentially extends along the outer peripheral edge of the surface 30a thereof.

The plurality of passage beads 53 protrude from the surface 30a of the first metal separator 30 toward the resin film equipped MEA 28. The passage beads 53 are provided respectively around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b.

Hereinafter, of the plurality of passage beads 53, a passage bead formed around the oxygen-containing gas supply passage 34a will be referred to as the “passage bead 53a”, and a passage bead formed around the oxygen-containing gas discharge passage 34b will be referred to as the “passage bead 53b”. The inlet buffer 50A (the plurality of bosses 50a) is provided between the passage bead 53a and the oxygen-containing gas flow field 48. The outlet buffer 50B (the plurality of bosses 50b) is provided between the passage bead 53b and the oxygen-containing gas flow field 48. The first metal separator 30 has bridges 80, 82 connecting the inside (the side of the fluid passages 34a, 34b) and the outside (the side of the oxygen-containing gas flow field 48) of the passage beads 53a, 53b.

As described above, the passage bead 53a surrounds the oxygen-containing gas supply passage 34a, and the bridge 80 is provided on a side portion 53a1 of the passage bead 53a that is positioned closer to the oxygen-containing gas flow field 48. The bridge 80 includes a plurality of tunnels 80a arranged at intervals. The height of the tunnels 80a is lower than the height of the passage bead 53a. The tunnels 80a are formed so as to protrude toward the resin film equipped MEA 28 (FIG. 1) by press-forming in a manner that the tunnels 80a intersect the passage bead 53a. One end of each of the tunnels 80a is opened to the oxygen-containing gas supply passage 34a. An opening 80b is provided at the other end of each of the tunnels 80a. In the structure, the oxygen-containing gas supply passage 34a and the oxygen-containing gas flow field 48 communicate with each other through the bridge 80.

As described above, the passage bead 53b surrounds the oxygen-containing gas discharge passage 34b, and the bridge 82 is provided on a side portion 53b1 of the passage bead 53b that is positioned closer to the oxygen-containing gas flow field 48. The bridge 82 includes a plurality of tunnels 82a arranged at intervals. The height of the tunnels 82a is lower than the height of the passage bead 53b. The tunnels 82a are formed so as to protrude toward the resin film equipped MEA 28 (FIG. 1) by press-forming in a manner that the tunnels 82a intersect the passage bead 53b. One end of each of the tunnels 82a is opened to the oxygen-containing gas discharge passage 34b. An opening 82b is provided at the other end of each of the tunnels 82a. In the structure, the oxygen-containing gas discharge passage 34b and the oxygen-containing gas flow field 48 communicate with each other through the bridge 82.

As shown in FIG. 3, the passage bead 53 of the first metal separator 30 and a passage bead 63, described later, of the second metal separator 32 are arranged face-to-face with each other across the resin film 46. The resin film 46 is held and sandwiched between the passage bead 53 of the first metal separator 30 and the passage bead 63 of the second metal separator 32.

The protruding height H2 of the bosses 50a from a base plate 30s (reference position) of the first metal separator 30 is lower than the protruding height H1 of the passage bead 53a from the base plate 30s. For example, the difference between the height of the bosses 50a and the height of the passage bead 53a (H1-H2) is in the range between 20 and 150 μm, and preferably in the range between 30 and 100 μm. The top portions 50t of the bosses 50a directly face the resin film 46.

Similarly, in FIG. 2, the protruding height of the bosses 50b from the base plate 30s is lower than the protruding height of the passage bead 53b from the base plate 30s. The difference between the height of the bosses 50b and the height of the passage bead 53b is the same as the difference between the height of the bosses 50a and the height of the passage bead 53a (H1-H2). The top portions of the bosses 50b directly face the resin film 46 (FIG. 2).

The protruding height H1 of the passage bead 53a and the protruding height of the passage bead 53b are the same as the protruding height of the inner bead 51a from the base plate 30s. The inner bead 51a is a bead seal formed around the oxygen-containing gas flow field 48.

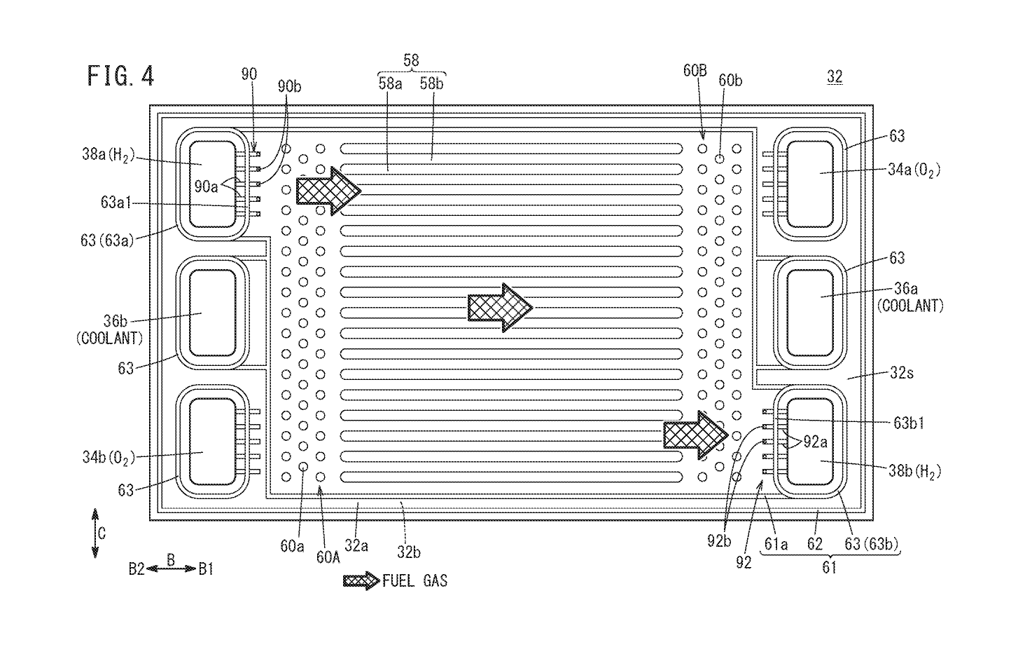

As shown in FIG. 1, the second metal separator 32 has a fuel gas flow field 58 on its surface 32a facing the resin film equipped MEA 28 (hereinafter referred to as the “surface 32a”). For example, the fuel gas flow field 58 extends in the direction indicated by the arrow B. As shown in FIG. 4, the fuel gas flow field 58 is connected to (in fluid communication with) the fuel gas supply passage 38a and the fuel gas discharge passage 38b. The fuel gas flow field 58 includes straight flow grooves 58b between a plurality of ridges 58a extending in the direction indicated by the arrow B. A plurality of wavy flow grooves may be provided instead of the plurality of straight flow grooves 58b.

An inlet buffer 60A including a plurality of bosses 60a is provided on a surface 32a of the second metal separator 32, between the fuel gas supply passage 38a and the fuel gas flow field 58. Further, an outlet buffer 60B including a plurality of bosses 60b is provided on the surface 32a of the second metal separator 32, between the fuel gas discharge passage 38b and the fuel gas flow field 58. The bosses 60a, 60b have a circular shape in a plan view (view in the stacking direction). The bosses 60a, 60b may have an oval shape or a linear shape in a plan view (view in the stacking direction).

A second seal line 61 is formed on the surface 32a of the second metal separator 32 by press-forming. The second seal line 61 protrudes toward the resin film equipped MEA 28. Resin material may be fixed to protruding front surfaces of the second seal line 61 by printing, coating, etc. For example, polyester fiber is used as the resin material. The resin material may be provided on the resin film 46.

The second seal line 61 includes a bead seal 61a (hereinafter referred to as the “inner bead 61a”) provided around the fuel gas flow field 58, the inlet buffer 60A and the outlet buffer 60B, a bead seal 62 (hereinafter referred to as the “outer bead 62”) provided outside the inner bead 61a along the outer periphery of the second metal separator 32, and a plurality of bead seals 63 (hereinafter referred to as the “passage beads 63”) provided respectively around the plurality of fluid passages (fluid passage 38a, etc.). The outer bead 62 protrudes from the surface 32a of the second metal separator 32, and circumferentially extends along the outer peripheral edge of the surface 32a thereof.

The plurality of passage beads 63 protrude from the surface 32a of the second metal separator 32. The passage beads 63 are provided respectively around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b.

Hereinafter, of the plurality of passage beads 63, a passage bead formed around the fuel gas supply passage 38a will be referred to as the “passage bead 63a”, and a passage bead formed around the fuel gas discharge passage 38b will be referred to as the “passage bead 63b”. The above described inlet buffer 60A (the plurality of bosses 60a) is provided between the passage bead 63a and the fuel gas flow field 58. The above described outlet buffer 60B (the plurality of bosses 60b) is provided between the passage bead 63b and the fuel gas flow field 58. The second metal separator 32 has bridges 90, 92 connecting the inside (the side of the fluid passages 38a, 38b) and the outside (the side of the fuel gas flow field 58) of the passage beads 63a, 63b.

As described above, the passage bead 63a surrounds the fuel gas supply passage 38a, and the bridge 90 is provided on a side portion 63a1 of the passage bead 63a that is positioned closer to the fuel gas flow field 58. The bridge 90 includes a plurality of tunnels 90a arranged at intervals. The height of the tunnels 90a is lower than the height of the passage bead 63a. The tunnels 90a are formed so as to protrude toward the resin film equipped MEA 28 (FIG. 1) by press-forming in a manner that the tunnels 90a intersect the passage bead 63a. One end of each of the tunnels 90a is opened to the fuel gas supply passage 38a. An opening 90b is provided at the other end of each of the tunnels 90a. In the structure, the fuel gas supply passage 38a and the fuel gas flow field 58 communicate with each other through the bridge 90.

As described above, the passage bead 63b surrounds the fuel gas discharge passage 38b, and the bridge 92 is provided on a side portion 63b1 of the passage bead 63b that is positioned closer to the fuel gas flow field 58. The bridge 92 includes a plurality of tunnels 92a arranged at intervals. The height of the tunnels 92a is lower than the height of the passage bead 63b. The tunnels 92a are formed so as to protrude toward the resin film equipped MEA 28 (FIG. 1) by press-forming in a manner that the tunnels 92a intersect the passage bead 63b. One end of each of the tunnels 92a is opened to the fuel gas discharge passage 38b. An opening 92b is provided at the other end of each of the tunnels 92a. In the structure, the fuel gas discharge passage 38b and the fuel gas flow field 58 communicate with each other through the bridge 92.

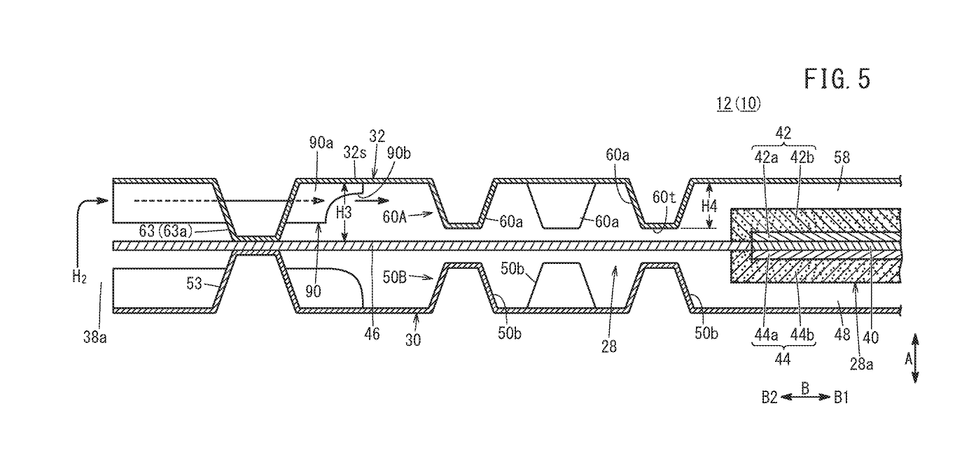

As shown in FIG. 5, the protruding height H4 of the bosses 60a from a base plate 32s (reference position) of the second metal separator 32 is lower than the protruding height H3 of the passage bead 63a from the base plate 32s. For example, the difference between the height of the bosses 60a and the height of the passage bead 63a (H3-H4) is in the range between 20 and 150 μm, and preferably in the range between 30 and 100 μm. The top portions 60t of the bosses 60a directly face the resin film 46.

Similarly, in FIG. 4, the protruding height of the bosses 60b from the base plate 32s is lower than the protruding height of the passage bead 63b from the base plate 32s. The difference between the height of the bosses 60b and the height of the passage bead 63b is the same as the difference between the height of the bosses 60a and the height of the passage bead 63a (H3-H4). The top portions of the bosses 60b directly face the resin film 46.

The protruding height H3 of the passage bead 63a and the protruding height of the passage bead 63b are the same as the protruding height of the inner bead 61a from the base plate 32s. The inner bead 61a is a bead seal formed around the fuel gas flow field 58.

As shown in FIG. 1, a coolant flow field 66 is formed between the surface 30b of the first metal separator 30 and the surface 32b of the second metal separator 32 that are joined together. The coolant flow field 66 is connected to (in fluid communication with) the coolant supply passage 36a and the coolant discharge passage 36b. The coolant flow field 66 is formed by stacking a back surface of the first metal separator 30 provided with the oxygen-containing gas flow field 48 and a back surface of the second metal separator 32 provided with the fuel gas flow field 58. The first metal separator 30 and the second metal separator 32 are joined together by welding outer peripheries thereof and areas around the fluid passages. The first metal separator 30 and the second metal separator 32 may be joined together by brazing, instead of welding.

Operation of the power generation cell 12 having the above structure will be described below.

Firstly, as shown in FIG. 1, an oxygen-containing gas such as the air is supplied to the oxygen-containing gas supply passage 34a. A fuel gas such as a hydrogen-containing gas is supplied to the fuel gas supply passage 38a. Coolant such as pure water, ethylene glycol, oil is supplied to the coolant supply passages 36a.

As shown in FIG. 3, the oxygen-containing gas is introduced from the oxygen-containing gas supply passage 34a into the oxygen-containing gas flow field 48 of the first metal separator 30 through the bridge 80 and the inlet buffer 50A. Then, as shown in FIG. 1, the oxygen-containing gas flows along the oxygen-containing gas flow field 48 in the direction indicated by the arrow B, and the oxygen-containing gas is supplied to the cathode 44 of the membrane electrode assembly 28a.

In the meanwhile, as shown in FIGS. 4 and 5, the fuel gas is introduced from the fuel gas supply passage 38a into the fuel gas flow field 58 of the second metal separator 32 through the bridge 90 and the inlet buffer 60A. Then, as shown in FIG. 1, the fuel gas flows along the fuel gas flow field 58 in the direction indicated by the arrow B, and the fuel gas is supplied to the anode 42 of the membrane electrode assembly 28a.

Thus, in each of the membrane electrode assemblies 28a, the oxygen-containing gas supplied to the cathode 44 and the fuel gas supplied to the anode 42 are consumed in the electrochemical reactions in the first electrode catalyst layer 44a and the second electrode catalyst layer 42a to thereby generate electricity.

Then, after the oxygen-containing gas supplied to the cathode 44 has been consumed at the cathode 44, the oxygen-containing gas from the oxygen-containing gas flow field 48 flows through the bridge 82 toward the oxygen-containing gas discharge passage 34b, and then the oxygen-containing gas is discharged along the oxygen-containing gas discharge passage 34b in the direction indicated by the arrow A. Likewise, after the fuel gas supplied to the anode 42 has been consumed at the anode 42, the fuel gas from the fuel gas flow field 58 flows through the bridge 92 (FIG. 4) toward the fuel gas discharge passage 38b, and then the fuel gas is discharged along the fuel gas discharge passage 38b in the direction indicated by the arrow A.

Further, the coolant supplied to the coolant supply passage 36a flows into the coolant flow field 66 formed between the first metal separator 30 and the second metal separator 32, and then the coolant flows in the direction indicated by the arrow B. After the coolant has cooled the membrane electrode assembly 28a, the coolant is discharged from the coolant discharge passage 36b.

In this case, the power generation cell 12 of the embodiment of the present invention offers the following advantages.

As described above, in the power generation cell 12, the protruding height of the bosses 50a, 50b, 60a, 60b is lower than the protruding height of the passage beads 53a, 53b, 63a, 63b. In the structure, in the state where the tightening load is applied in the stacking direction, though the bosses 50a, 50b, 60a, 60b contact the resin film 46, no tightening load of the fuel cell stack is applied (or almost no tightening load is applied) to the bosses 50a, 50b, 60a, 60b. Therefore, it is possible to easily achieve a desired sealing performance by elastic deformation of the passage beads 53a, 53b, 63a, 63b. Further, it is possible to suppress increase in the tightening load of the fuel cell stack.

In the state where no tightening load is applied, the protruding height of the bosses 50a, 60a of the inlet buffers 50A, 60A is lower than the protruding height of the passage beads 53a, 63a. Further, in the state where no tightening load is applied, the protruding height of the bosses 50b, 60b of the outlet buffers 50B, 60B is lower than the protruding height of the passage beads 53b, 63b. In the structure, in both of the passage beads 53a, 63a adjacent to the inlet buffers 50A, 60A and the passage beads 53b, 63b adjacent to the outlet buffers 50B, 60B, a desired sealing performance is achieved easily. Therefore, it is possible to achieve further improvement in the sealing performance to a greater extent. Further, it is possible to suitably suppress increase in the tightening load to a greater extent.

The protruding length of all of the bosses 50a of the inlet buffer 50A, the protruding length of all of the bosses 50b of the outlet buffer 50B, the protruding length of all of the bosses 60a of the inlet buffer 60A, and the protruding length of all of the bosses 60b of the outlet buffer 60B are lower than the protruding lengths of the passage beads 53a, 53b, 63a, 63b. In the structure, it is possible to easily achieve a desired sealing performance by the passage beads 53a, 53b, 63a, 63b, and suppress increase in the tightening load of the fuel cell stack more effectively.

The protruding height of the bosses 50a, 50b provided in the first metal separator 30 having the oxygen-containing gas flow field 48 is lower than the protruding height of the passage beads 53a, 53b. Further, the protruding height of the bosses 60a, 60b provided on the second metal separator 32 having the fuel gas flow field 58 is lower than the protruding height of the passage bead 63a, 63b. In the structure, since the desired sealing performance is obtained easily in both of the cathode and the anode, it is possible to achieve further improvement in the sealing performance. Further, it is possible to suppress increase in the tightening load to a greater extent.

The top portions of the bosses 50a, 50b, 60a, 60b directly face the resin film 46. In the structure, since no shims, etc. are required for adjustment of clearance between the bosses 50a, 50b, 60a, 60b and the resin film 46, the structure of the power generation cell 12 is simplified.

The present invention is not limited to the above described embodiment. Various modifications may be made without departing from the scope of the present invention.

What is claimed is:

1. A power generation cell comprising:
a resin film equipped membrane electrode assembly including a membrane electrode assembly and a resin film provided on an outer periphery of the membrane electrode assembly; and
metal separators provided respectively on both sides of the resin film equipped membrane electrode assembly, the power generation cell being formed by stacking the resin film equipped membrane electrode assembly and the metal separators together,
wherein each of the metal separators comprises:
a reactant gas flow field configured to allow a reactant gas to flow along an electrode surface of the membrane electrode assembly;
a reactant gas passage connected to the reactant gas flow field and penetrating through the metal separator in a separator thickness direction;
a passage bead for sealing, formed around the reactant gas passage and protruding in the separator thickness direction; and
bosses configured to distribute flow of a reactant gas, the bosses being provided between the reactant gas flow field and the passage bead, and protruding in the separator thickness direction, and
wherein the resin film is held and sandwiched between the passage beads of a pair of the metal separators; and
a protruding height of the bosses is lower than a protruding height of the passage bead.

2. The power generation cell according to claim 1, wherein the metal separator comprises an inlet buffer including the bosses provided at an inlet side of the reactant gas flow field, and an outlet buffer including the bosses provided at an outlet side of the reactant gas flow field;
the protruding height of the bosses of the inlet buffer is lower than the protruding height of the passage bead formed around the reactant gas passage configured to supply the reactant gas to the reactant gas flow field; and
the protruding height of the bosses of the outlet buffer is lower than the protruding height of the passage bead formed around the reactant gas passage configured to receive the reactant gas from the reactant gas flow field.

3. The power generation cell according to claim 1, wherein the protruding height of all of the bosses is lower than the protruding height of the passage bead.

4. The power generation cell according to claim 1, wherein, among the pair of the metal separators, one of the metal separators includes:
an oxygen-containing gas flow field as one of the reactant gas flow fields;
an oxygen-containing gas passage as one of the reactant gas passages;
one of the passage beads that is formed around the oxygen-containing gas passage; and
one group of the bosses provided between the one of the passage beads and the oxygen-containing gas flow field,
another one of the metal separators includes:
a fuel gas flow field as another one of the reactant gas flow fields;
a fuel gas passage as another one of the reactant gas passages;
another one of the passage beads that is formed around the fuel gas passage; and
another group of the bosses provided between the other one of the passage beads and the fuel gas flow field,
and wherein the protruding height of the bosses in the one group is lower than the protruding height of the one of the passage beads; and
the protruding height of the bosses in the other group is lower than the protruding height of the other one of the passage beads.

5. The power generation cell according to claim 1, wherein top portions of the bosses directly face the resin film.

6. The power generation cell according to claim 1, wherein the metal separator comprises a bead seal formed around the reactant gas flow field and protruding in the separator thickness direction; and
a protruding height of the bead seal is a same as the protruding height of the passage bead.

7. The power generation cell according to claim 1, wherein each of the bosses has a circular shape or an oval shape in a plan view.

8. The power generation cell according to claim 1, wherein in a state where a tightening load in a stacking direction is applied to the power generation cell, the bosses contact the resin film without being deformed elastically.
